(19) United States
(12) Patent Application Publication
(10) Pub. No.: US 2007/0008411 A1
(43) Pub. Date: Jan. 11, 2007

(54) Sensor-camera-ganged intrusion detecting apparatus

(76) Inventors: Masahiko Shibata, Otsu-shi, Shiga (JP); Ryosuke Miwa, Shiga (JP)

Correspondence Address: SUGHRUE MION, PLLC, 2100 PENNSYLVANIA AVENUE, N.W., SUITE 800, WASHINGTON, DC, 20037, US

(21) Appl. No.: 10/570,137

(22) PCT Filed: Sep. 7, 2004
(86) PCT No.: PCT/JP04/12995

§ 371 Date: Mar. 1, 2006

(51) Int. Cl. H04N 7/18; G08B 21/00

(52) U.S. Cl. 348/152; 340/540

(57) ABSTRACT

A sensor-camera ganged intrusion detecting apparatus according to the present invention includes a sensor unit 1 for detecting an object Q in terms of a change in amount of reception of detection rays from a detection area A0 to An, an image processing unit 4 for detecting the object Q in terms of a change of a video signal MS from a specific area AC1 in an area shot by a camera 2, which specific area AC1 has a portion overlapped with the detection area A0 to An, an area setting unit 3 for setting the specific area AC1 on a monitor screen 6 coupled with the camera 2, and a detection signal generating unit 5 for generating an object detection signal DE1 based on a detection signal PD from the sensor unit 1 and a detection signal MD1 from the image processing unit 4.

### FIELD OF THE INVENTION

The present invention relates to a sensor-camera ganged intrusion detecting apparatus utilizing a sensor and a camera for detecting an object intruding into the premises.

### BACKGROUND ART

Hitherto, the conventional sensor-camera ganged intrusion detecting apparatus generally includes a monitoring camera and an intrusion detecting sensor and is so designed that when the detecting sensor detects an intrusion of an object, the camera is oriented in a direction in which the object is detected to thereby shoot the intruding object. (See the Japanese Laid-open Patent Publication No. 2003-44965.)

### DISCLOSURE OF THE INVENTION

However, with this sensor-camera ganged intrusion detecting apparatus, it often occurs that an object intruding into a predetermined detection area cannot be detected assuredly. In other words, since the detecting sensor covers a large area and may respond to, for example, light coming from an automotive vehicle running outside the detection area, an erroneous operation such as shooting an image outside the detection area often occurs. If the detection area covered by the detection sensor is set to a narrower area, the erroneous operation can be minimized, but rays from the detecting sensor cannot be ascertained with naked eyes and, therefore, a large length of time is required to accomplish an accurate setting of the detection area.

In view of the foregoing, the present invention has for its object to provide a sensor-camera ganged intrusion detecting apparatus capable of assuredly detecting an object intruding into a predetermined area.

In order to accomplish the foregoing object, a sensor-camera ganged intrusion detecting apparatus according to the present invention includes a sensor unit for detecting an object in terms of a change in amount of reception of detection rays from a detection area, an image processing unit for detecting the object in terms of a change of a video signal from a specific area in an area shot by a camera, which specific area has a portion overlapped with the detection area, an area setting unit for setting the specific area on a monitor screen coupled with the camera, and a detection signal generating unit for generating an object detection signal based on a detection signal from the sensor unit and a detection signal from the image processing unit.

According to the foregoing construction, when the object intrudes into the specific area preset by the area setting unit, the video signal indicative of the specific area, which is shot by the camera and is then fed to the image processing unit, undergoes a change and, at the same time, the amount of reception of the detection rays in the sensor unit also undergoes a change, with respective detection signals consequently outputted from the sensor unit and the image processing unit. Based on those detection signals, the detection signal generating unit outputs an object detection signal, indicating the intruding object. Since the specific area that defines the detection area is set on the monitor screen, the area to be detected can be accurately set by viewing the monitor screen and, therefore, the detection of the intruding object can be accomplished assuredly with an erroneous operation minimized.

In a preferred embodiment of the present invention, the specific area may include first and second specific areas. The detection signal generating unit may generate the object detection signal in response to both of the detection signal from the sensor unit and the detection signal from the image processing unit in association with the first specific area, or in response to a detection signal from the image processing unit in association with the second specific area.

According to the foregoing construction, the first and second specific areas are set by the area setting unit, and the detection signal generating unit generates the object detection signal (1) in response to both of the detection signal from the sensor unit and the detection signal from the image processing unit in association with the first specific area when the object is detected in the first specific area as a result of a change in the image of the first specific area shot by the camera and when the object is detected in response to the change in amount of reception of the detection rays from the sensor unit, or (2) in response to the detection signal from the image processing unit in association with the second specific area. Accordingly, detection of the intruding object in the first and second specific areas can be assuredly achieved over a wide range. If the first specific area is defined as an area where a specifically accurate detection is required, the object detection signal can be outputted only when both of the detection signal form the sensor unit and the detection signal from the image processing unit are received as far as this area is concerned and, therefore, an accurate detection of the intruder can be achieved in the first specific area. Also, since the first and second specific areas, which form respective parts of the detection area, can be set on the monitor screen, the area to be watched can be accurately set by viewing the monitor screen and, therefore, the detection of the intruding object can be assuredly achieved with the erroneous operation minimized.

In another preferred embodiment of the present invention, the detection signal generating unit may generate a first object detection signal in response to receipt of both of the detection signal from the sensor unit and the detection signal from the image processing unit in association with the first specific area and also generate a second object detection signal in response to receipt of the detection signal from the image processing unit in association with the second specific area.

According to the construction described above, first and second specific areas are set by the area setting unit, and the detection signal generating unit generates the first object detection signal based on both of the detection signal from the sensor unit and the detection signal from the image processing unit in association with the first specific area, when the object in the first specific area is detected in terms of a change in the image of the first specific area shot by the camera and when the object is detected in terms of a change in amount of reception of detection rays from the sensor unit. Also, when the object in the second specific area is detected in terms of a change in the image of the second specific area shot by the camera, the detection signal generating unit outputs the second object detection signal. Accordingly, detection of the intruding object in the first specific area and detection of the intruding object in the second specific area can be separately achieved over a wide range and the stage security is possible because of the detection in each of the specific areas. Moreover, since the first and second specific areas, which form respective parts of the detection area, can be set on the monitor screen, the area to be watched can be accurately set by viewing the monitor screen and, therefore, the detection of the intruding object can be assuredly achieved with the erroneous operation minimized.

In a further preferred embodiment of the present invention, the sensor-camera ganged intrusion detecting apparatus may also include a nighttime adjusting device that is operable, when the brightness of an area (specific area) shot by the camera becomes a value equal to or lower than a predetermined brightness, to disable the image processing unit and to allow the detection signal generating unit to generate a first object detection signal in response to only the detection signal from the sensor unit. According to this construction, when the environments get dark and the brightness of the area shot by the camera is equal to or lower than the predetermined brightness, the first object detecting signal is outputted from the detection signal generating unit in response to only the detection signal outputted from the sensor unit, and therefore the intruding object can be detected assuredly.

In a still further preferred embodiment of the present invention, the detection rays may be infrared rays and the sensor-camera ganged intrusion detecting apparatus may also include a temperature adjusting device operable, when the temperature of the detection area becomes a value equal to or higher than a predetermined temperature, to disable the sensor unit and to allow the detection signal generating unit to generate a first object detecting signal in response to only the detection signal from the image processing unit. According to this construction, even when an accurate detection of the intruding object with the infrared rays becomes difficult to achieve as a result of the ambient temperature getting high, for example, during summer, the intruding object can be detected assuredly with the first object detection signal outputted from the detection signal generating unit in response to only the detection signal from the image processing unit.

In a yet further preferred embodiment of the present invention, the specific area may include first and second specific areas, and the detection signal generating unit may generate the object detection signal when it receives both of the detection signal from the sensor unit and the detection signal from the image processing unit in association with the first specific area, or when it receives the detection signal from the sensor unit, but does not receive the detection signal from the image processing unit in association with the second specific area. According to this construction, in the case where the area desired to be watched adjoin, for example, the road, such road outside the area desired to be watched (the first specific area) can be set as the second specific area. By so doing, only the object entering in the first specific area can be detected, but any automotive vehicles and/or people moving within the second specific area will not be detected. Accordingly, the stable sensor-camera ganged intrusion detecting apparatus can be obtained.

In a yet still preferred embodiment of the present invention, the sensor unit may include a passive infrared detector for detecting far infrared rays from the detection area. According to this construction, detection of the object with the sensor unit can be assuredly achieved with a simplified structure.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims.

In the accompanying drawings, like reference numerals are used to denote like parts throughout the several views, and:

FIG. 1 is a perspective view showing the manner in which a sensor-camera ganged intrusion detecting apparatus according to a first preferred embodiment of the present invention is installed;

FIG. 2 is a circuit block diagram showing an electric circuit employed in the sensor-camera ganged intrusion detecting apparatus;

FIG. 3 is a front elevational view showing a monitor screen employed in the sensor-camera ganged intrusion detecting apparatus shown in FIG. 1;

FIG. 4 is a circuit block diagram showing the electric circuit employed in the sensor-camera ganged intrusion detecting apparatus according to a second preferred embodiment of the present invention;

FIG. 5 is a front elevational view showing the monitor screen employed in the sensor-camera ganged intrusion detecting apparatus shown in FIG. 4;

FIG. 6 is a circuit block diagram showing the electric circuit employed in the sensor-camera ganged intrusion detecting apparatus according to a third preferred embodiment of the present invention;

FIG. 7 is a circuit block diagram showing the electric circuit employed in the sensor-camera ganged intrusion detecting apparatus according to a fourth preferred embodiment of the present invention;

FIG. 8 is a circuit block diagram showing the electric circuit employed in the sensor-camera ganged intrusion detecting apparatus according to a fifth preferred embodiment of the present invention;

FIG. 9 is a plan view showing fields of view exhibited in the sensor-camera ganged intrusion detecting apparatus according to a sixth preferred embodiment of the present invention;

FIG. 10 is a circuit block diagram of the sensor-camera ganged intrusion detecting apparatus according to the sixth preferred embodiment of the present invention; and

FIG. 11 is a front elevational view showing the monitor screen employed in the sensor-camera ganged intrusion detecting apparatus shown in FIG. 10.

### DETAILED DESCRIPTION OF THE EMBODIMENTS

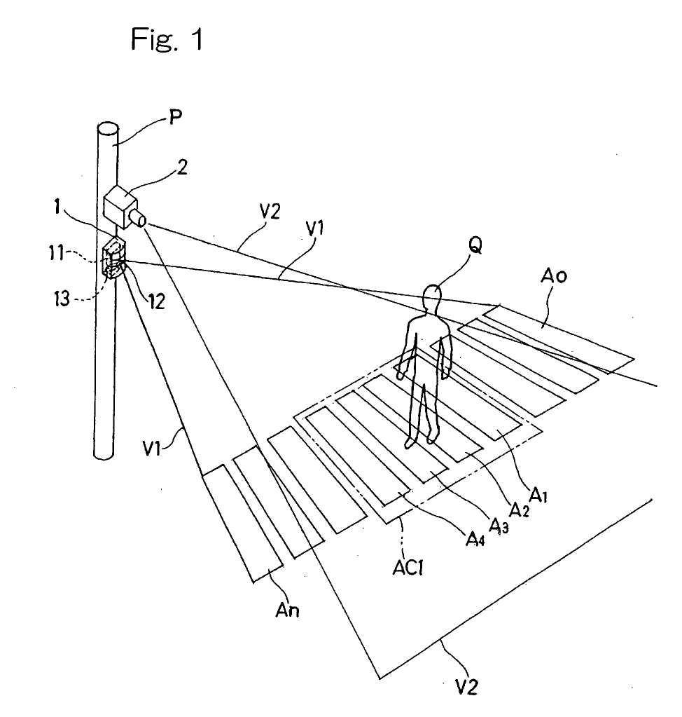

Hereinafter, preferred embodiments of a sensor-camera ganged intrusion detecting apparatus according to the present invention will be described with reference to the accompanying drawings. FIG. 1 illustrates a perspective view of the sensor-camera ganged intrusion detecting apparatus according to a first preferred embodiment of the present invention, showing an optical layout deployed in the site of installation thereof. This apparatus is fitted to a pole P or a wall of a building such as a house and a factory for detecting an object Q, for example, a human body or an animal intruding within a predetermined detection area defined in the outdoor space of the building, and includes a sensor unit 1 for defining a plurality of detection areas A0 to An in the outdoor space of the building and for detecting the intruding object Q, then moving within the detection areas A0 to An, in terms of change in amount of detection rays emanating from the object Q, and a CCD camera 2 for photo-taking such object Q.

The sensor unit 1 makes use of a passive infrared-red (PIR) system and includes a casing 10 accommodating therein a passive infrared detector 11 in the form of, for example, a pyroelectric element for detecting far infrared rays, which are the detection rays emanating from the intruding object Q within the detection areas A0 to An, a Fresnel lens 12 positioned forwardly of the passive infrared detector 11 and defining the detection areas A0 to An, and a signal generating circuit 13. This sensor unit 1 is operable such that when the far infrared rays emanating from the object Q, then intruding into the detection areas A0 to An, impinge upon the passive infrared detector 11 after having been collected by the Fresnel lens 12, the signal generating circuit 13 outputs a detection signal indicative of the intruding object Q in the event that the amount of light collected, that is, the amount of reception changes a predetermined value or more. Thus, when the passive infrared detector 11 is employed, the detection of the intruding object Q can be achieved with a simplified structure.

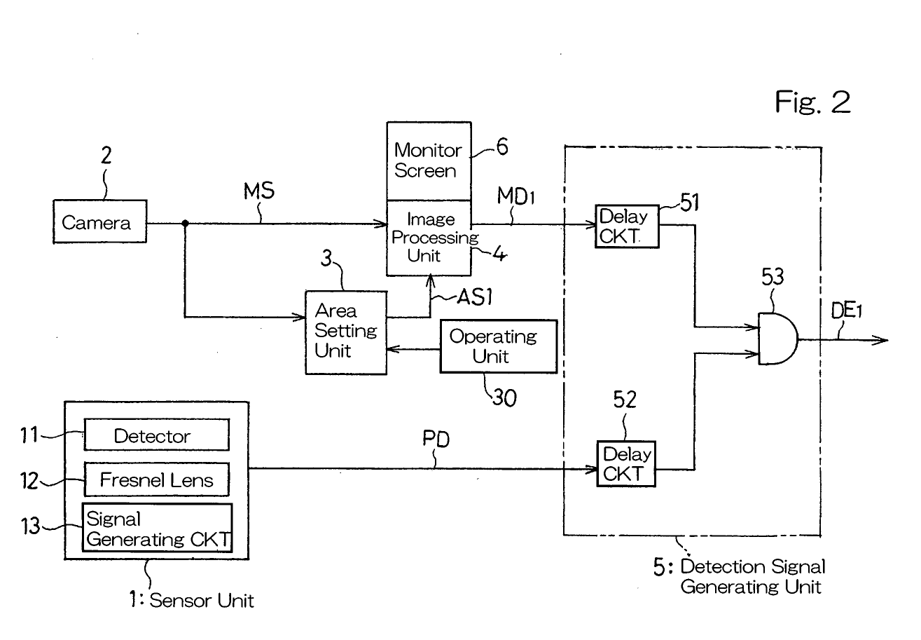

FIG. 2 illustrates a circuit block diagram showing an electric circuit employed in the sensor-camera ganged intrusion detecting apparatus. In addition to the sensor unit 1 and the CCD camera 2, this detecting apparatus includes a monitor screen 6 electrically connected with the camera 2, an area setting unit 3 for setting a first specific area AC1 on the monitor screen 6, a operating unit 30, for example, keys or a mouse for manually operating the area setting unit 3, an image processing unit 4 for detecting an object Q in terms of change of a video signal MS within the first specific area AC1, and a detection signal generating unit 5 operable in response to receipt of both of a detection signal PD from the sensor unit 1 and a detection signal MD1 from the image processing unit 4 to output a first object detection signal DE1. In the first embodiment now under discussion, to prevent the object detection signal from being outputted unnecessarily and to detect the intruding object Q assuredly, the detection signal generating unit 5 includes a first delay circuit 51 electrically connected with the image processing unit 4, a second delay circuit 52 electrically connected with the sensor unit 1, and an AND circuit 53 for outputting the first object detection signal DE1 when respective output signals are outputted from the first and second delay circuits 51 and 52. While the sensor unit 1 and the camera 2 are installed at the site desired to be watched, the area setting unit 3, the image processing unit 4, the detection signal generating unit 5 and the operating unit 30 are located in, for example, a security guard room distant from the site desired to be watched.

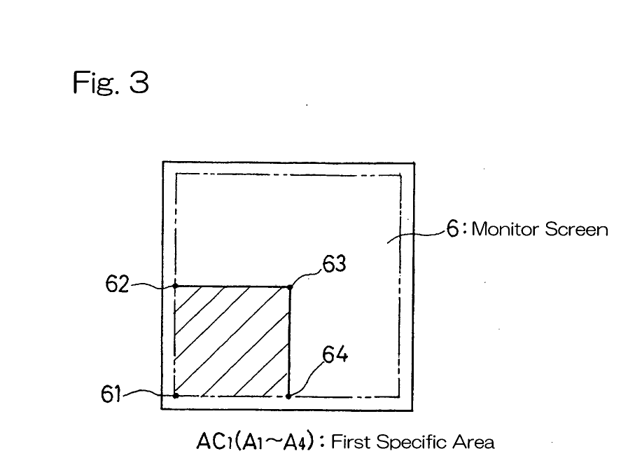

FIG. 3 illustrates the PC monitor screen 6. When the axes of coordinate of a video image viewed with the camera 2 are specified on the monitor screen 6 by manipulating the operating unit 30, that is, when four points 61 to 64 are specified on the monitor screen 6, a setting signal AS1 for setting the profile line of the area defined by the four points 61 to 64 is outputted from the area setting unit 3 to the image processing unit 4 to set such area as the first specific area AC1 in the image processing unit 4, and, at the same time, to display this specific area AC1 on the monitor screen 6. The image processing unit 4 detects a change of the video signal within this first specific area AC1.

As shown in FIG. 1, since the detection areas A0 to An of the sensor unit 1, that is, the field of view (coverage) V1 of the sensor unit 1 is difficult to set accurately, those detection areas A0 to An are roughly set and, on the other hand, the field of view V2 of the camera 2 is so set as to extend a larger distance, but encompass a smaller width than the field of view V1. The first specific area AC1 is encompassed within a portion of the field of view V2 of the camera 2 and the areas A1 to A4, which is part of the entire detection areas A0 to An of the sensor unit 1, are included within this first specific area AC1. In other words, the specific area AC1 and the entire detection areas A0 to An are partly overlapped. When the object Q intrudes into the detection areas A1 to A4 encompassed within the first specific area AC1, the detection signal generating unit 5 shown in FIG. 2 outputs (alarms) the first object detection signal DE1.

According to the first embodiment described above, in the event that of the entire detection areas A0 to An aimed at by the sensor unit 1, the object Q intrudes into the predetermined detection areas A1 to A4 encompassed within the first specific area AC1 set by the area setting unit 3 within the imaging area of the camera 2, the first object detection signal DE1 indicative of the detection of the intruding object Q can be outputted from the detection signal generating unit 5. In other words, as shown in FIG. 2, in response to the intruding object Q, the detection signal PD in the form of a rectangular wave signal is outputted from the sensor unit 1 and, also, in response to change of the video signal MS within the first specific area AC1, a detection signal MD1 can be outputted form the image processing unit 4. The image processing unit 4 makes use of, for example, the standard image processing technology, in which when a brightness signal contained in the video signal MS varies a predetermined width or more within a predetermined length of time, the detection signal MD1 is outputted. The respective detection signals PD and MD1 from the sensor unit 1 and the image processing unit 4 are delayed by the corresponding first and second delay circuits 51 and 52 of the detection signal generating unit 5, suppressing an erroneous operation due to an error signal, and are subsequently fed to the AND circuit 53, which outputs the first detection signal DE1 when triggered on. Based on this signal DE1, warning takes place within the security guard room and, at the same time, generation of sounds and/or light occurs at the site of watch.

As described above, since the image area shot by the camera 2, or the area displayed on the monitor screen 6 is set to encompass the first specific area AC1 by the area setting unit 3 and since the object detection signal is outputted in response to the detection of the intruding object Q in the specific area AC1 through both of the sensor unit 1 and the camera 2, the intruding object Q can be accurately detected with an erroneous operation minimized. Since the first specific area AC1, which defines the detection area, can be set on the monitor screen 6, no one needs to go to the site of watch and the area to be detected at the site of watch can be accurately set by viewing the monitor screen 6 within the security guard room, once both of the sensor unit 1 and the camera 2 are installed at the site of watch. Accordingly, the detection of the intruding object can be accurately achieved with the erroneous operation minimized and the manipulation of setting the watch area can be easily performed.

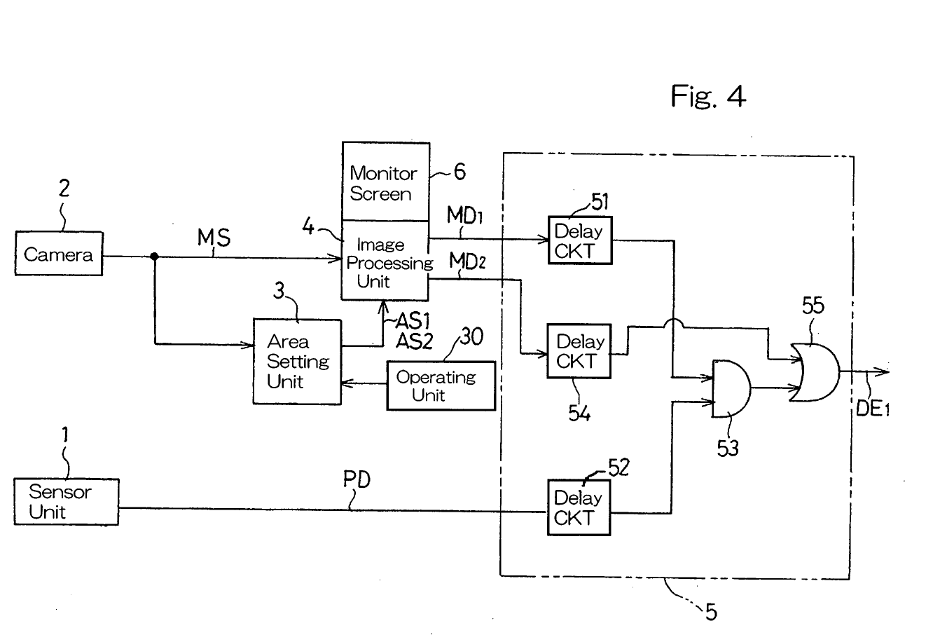

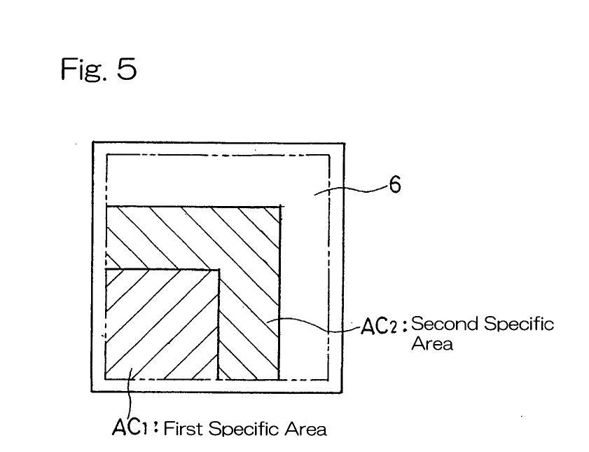

FIG. 4 illustrates a circuit block diagram showing the electric circuit of the sensor-camera ganged intrusion detecting apparatus according to a second preferred embodiment of the present invention and FIG. 5 illustrates the monitor screen 6 used therewith. This detecting apparatus of the second embodiment differs from that of the first embodiment in that as shown in FIG. 5, the image area shot by the camera 2 is set to have a first specific area AC1 and a second specific area AC2 outside the first specific area AC1, in reference to first and second setting signals AS1 and AS2 outputted from the area setting unit 3, so that the image processing unit 4 can output first and second detection signals MD1 and MD2 to the detection signal generating unit 5 when the video signal MS from the camera 2 shown in FIG. 4 changes in those first and second specific areas AC1 and AC2, respectively. By way of example, the first specific area AC1 may represent an area on an outdoor side of an entrance of the building where the accurate detection of the intruder is required and the second specific area AC2 may represent an area distant from the entrance. The detecting signal generating unit 5 is additionally provided with a third delay circuit 54, to which the second detection signal MD2 is supplied, and also with an OR circuit 55 to which an output signal from this third delay circuit 54 and an output signal from the AND circuit 53 are inputted.

According to the second embodiment described above, the first and second specific areas AC1 and AC2 are set in the image processing unit 4 by the respective setting signals AS1 and AS2 outputted from the area setting unit 3. When the image processing unit 4 detects the change of the video signal MS that occurs within those specific areas AC1 and AC2, the first and second detection signals MD1 and MD2 are outputted from the image processing unit 4. The first detection signal MD1 and the second detection signal MD2 are inputted respectively to the first delay circuit 51 and the second delay circuit 54. Also, the first detection signal MD1 from the first delay circuit 51 and the detection signal PD from the sensor unit 1 are supplied to the AND circuit 53 of the detection signal generating unit 5 in a manner similar to that shown and described in connection with the previously described first embodiment. Also, the output signal from the AND circuit 53 and the output signal from the third delay circuit 54 are inputted to the OR circuit 55, from which a first object detection signal DE1 is outputted to thereby detect the intruding object Q.

Accordingly, as for the detection in the first specific area AC1, since the object detection signal DE1 is outputted only when both of the sensor unit 1 and the camera 2 detect the intruding object Q, the detection of the intruding object Q can be accurately achieved with the erroneous operation minimized. On the other hand, as for the detection in the second specific area AC2, since the object detection signal DE1 can be outputted only by the detection of the camera 2, the second specific area AC2 is set to encompass, for example, a larger and deeper detection area than the detection area covered by the sensor unit 1. Accordingly, the area to be watched can be easily enlarged. Also, since the first and second specific areas AC1 and AC2, which form parts of the detection area, can be set on the monitor screen 6, the area desired to be watched can be accurately set by viewing the monitor screen 6 and the manipulation to set the watch area can easily be accomplished.

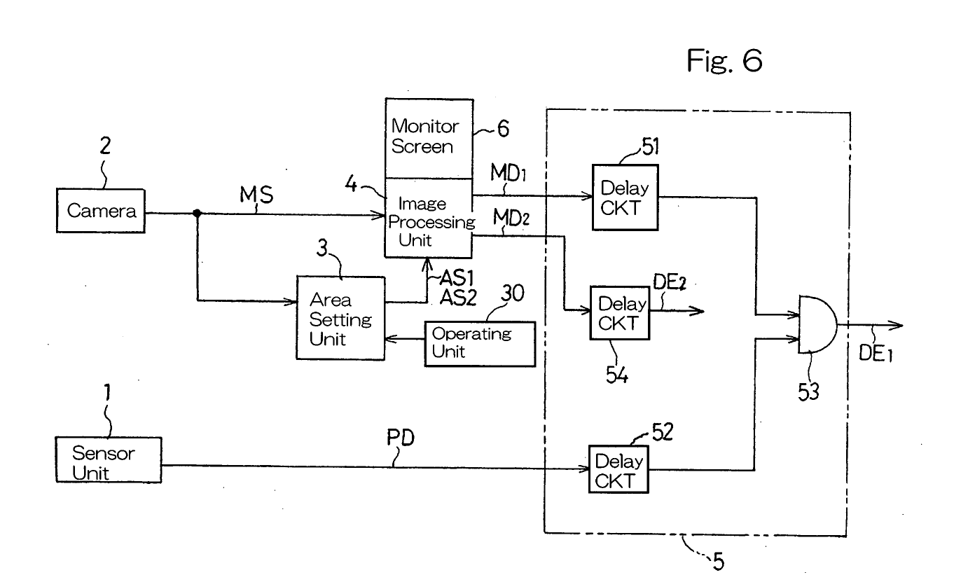

FIG. 6 illustrates an electric circuit of the sensor-camera ganged intrusion detecting apparatus according to a third preferred embodiment of the present invention. This detecting apparatus of the third embodiment is similar to that of the second embodiment, except that a second object detection signal DE2 can be separately outputted from the third delay circuit 54, together with the first object detection signal DE1 outputted from the AND circuit 53 of the detection signal generating unit 5.

According to the third embodiment, the first detection signal MD1 from the image processing unit 4 and the detection signal PD from the sensor unit 1 are supplied to the AND circuit 53 through the first and second delay circuits 51 and 52 of the detection signal generating unit 5, respectively, from which AND circuit 53 the first object detection signal DE1 is outputted. Also, the second object detection signal DE2 is outputted from the third delay circuit 54 based on the second detection signal MD2 from the image processing unit 4. By so doing, detection of the intruding object Q within the first and second specific areas AC1 and AC2 can be discriminated and, accordingly, when a loudspeaker and a light emitting device, for example, are installed at the site of watch, an attention calling voice from the loudspeaker can be emitted to the intruder Q in response to reception of the second object detecting signal DE2 resulting from the detection in the second specific area AC2, and both a threat sound from the loudspeaker and light from the light emitting device can be generated in response to reception of the first object detection signal DE1 resulting from the detection in the first specific area AC1, thereby accomplishing a stage security to expel the intruder Q.

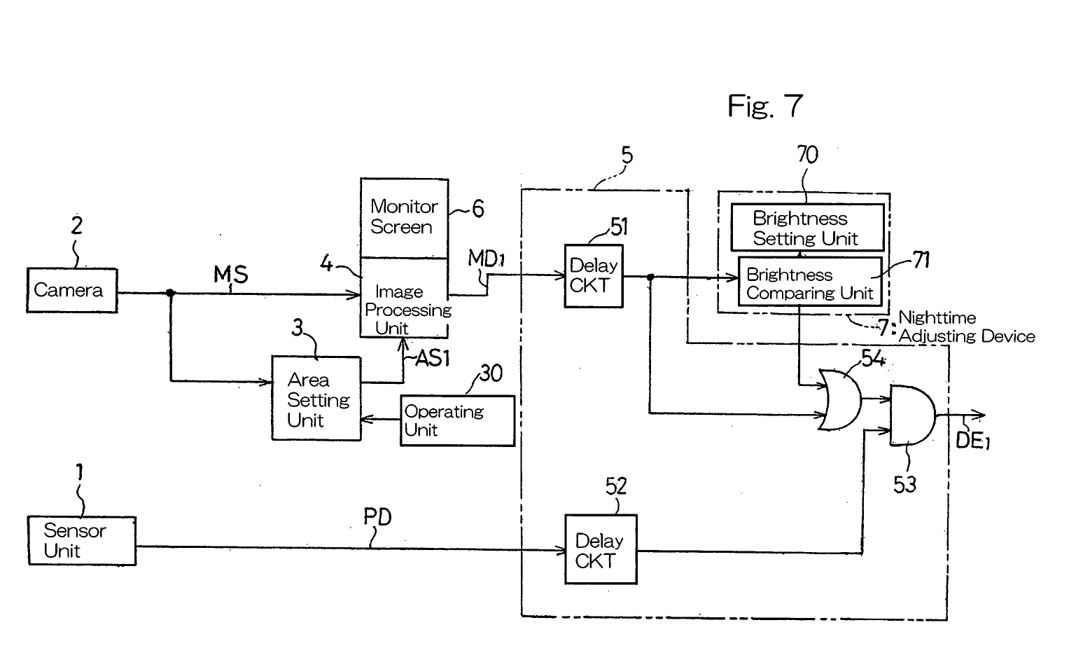

FIG. 7 illustrates an electric circuit of the sensor-camera ganged intrusion detecting apparatus according to a fourth preferred embodiment of the present invention. This detecting apparatus is so designed that when the environments get dark, reduction in performance of the camera 2 can be compensated for, and is similar to that of the first embodiment in FIG. 2, except that a nighttime adjustment device 7 including a brightness setting unit 70 and a brightness comparing unit 71 is additionally employed on an output side of the first delay circuit 51 of the detection signal generating unit 5. The brightness comparing unit 71 compares the brightness of the image processed in the image processing unit 4, fed from the first delay circuit 51, with a predetermined brightness preset in the brightness setting unit 70. Also, the detection signal generating unit 5 of the detecting apparatus is provided with an OR circuit 54, to which respective signals from the brightness comparing unit 71 and the first delay circuit 51 are supplied, and also with an AND circuit 53, to which an output signal from the OR circuit 54 and an output signal from the second delay circuit 52 connected with the sensor unit 1 are supplied, are employed.

According to this fourth embodiment, the brightness of the first specific area AC1 shot with the camera 2 is compared in the brightness comparing unit 71 with the predetermined brightness preset in the brightness setting unit 70. When the brightness of the first specific area AC1 becomes a value lower than the predetermined brightness as a result that the environments become dark because of night or under the influence of the weather, the brightness comparing unit 71 supplies a high level signal to the OR circuit 54 which in turn outputs a high level signal at all times to the AND circuit 53. Accordingly, even during the absence of the detection signal MD1 from the image processing unit 4, the detection signal PD from the sensor unit 1 causes the first object detection signal DE 1 to be outputted from the AND circuit 53. In this way, when the image processing unit 4 is incapable of outputting the detection signal MD1 as a result of the environments getting dark, the detection of the intruding object Q can be assuredly accomplished based only on the detection signal PD from the sensor unit 1. When the environments are bright, the object detection signal DE1 is outputted only when the detection signal PD from the sensor 1 and the detection signal MD1 based on the video signal MS from the camera 2 are inputted simultaneously to the AND gate 53.

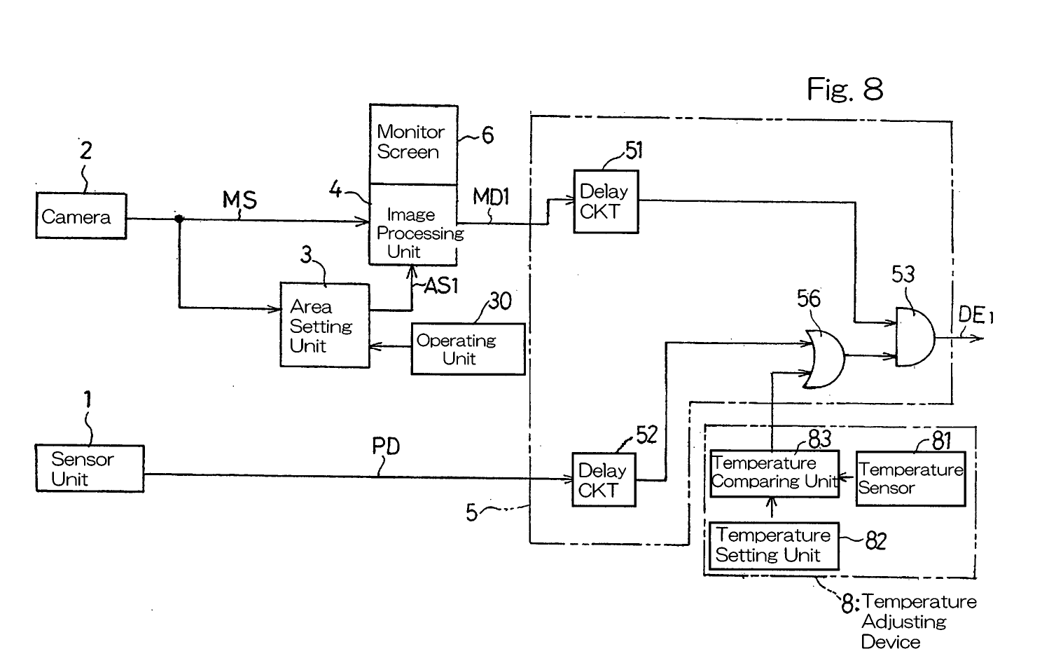

FIG. 8 illustrates an electric circuit of the sensor-camera ganged intrusion detector according to a fifth preferred embodiment of the present invention. This detecting apparatus is so designed that reduction in performance of the sensor unit 1 resulting from increase of the ambient temperature can be compensated for. The detecting apparatus of the fifth embodiment is similar to that of the first embodiment in FIG. 2, except that the detection signal generating unit 5 is additionally provided with a temperature adjusting device 8. The temperature adjusting device includes a temperature sensor 81 for detecting the temperature of the detection areas A0 to An covered by the sensor unit 1, a temperature setting unit 82 for presetting a predetermined temperature, and a temperature comparing unit 83 for comparing the temperature detected by the temperature sensor 81 with the predetermined temperature preset by the temperature setting unit 82. Also, an OR circuit 54, to which an output signal from the temperature comparing unit 83 and the signal from the second delay circuit 52 connected with the sensor unit 1 are inputted, and an AND circuit 53, to which an output signal from the OR circuit 56 and the output signal from the first delay circuit 51 are inputted, are employed in the detection signal generating unit 5.

According to this fifth embodiment, the temperature of the detection areas A0 to An covered by the sensor unit 1 is detected by the temperature sensor 81, and the temperature so detected is compared by the temperature comparing unit 83 with the predetermined temperature preset by the temperature setting unit 82. When the temperature of the detection areas A0 to An becomes a value equal to or higher than the predetermined temperature, the temperature comparing unit 83 outputs a high level signal to the OR circuit 56, which in turn outputs a high level signal at all times to the AND circuit 53. Accordingly, even during the absence of the detection signal PD from the sensor unit 1, only the detection signal MD1 from the image processing unit 4 causes the AND circuit 53 to output the first object detection signal DE1. Where an infrared detector is used for the sensor unit 1, the detection of the intruding object Q becomes inaccurate with infrared rays due to the increased temperature of the detection areas A0 to An, for example, during summer. But, in the fifth embodiment, when the temperature detected by the temperature sensor 81 is of a value equal to or higher than the predetermined temperature, the detection of the intruding object Q can be assuredly achieved only based on the detection signal MD1 from the image processing unit 4. On the other hand, when the detected temperature is lower than the predetermined temperature, the object detection signal DE1 can be outputted only when the detection signal PD from the sensor unit 1 and the detection signal MD1 based on the image signal from the camera 2 are simultaneously inputted to the AND circuit 53.

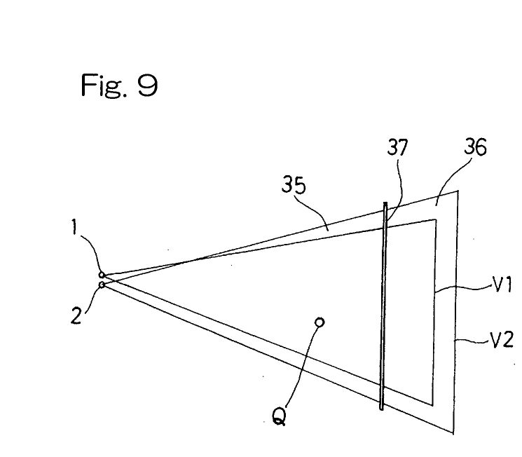

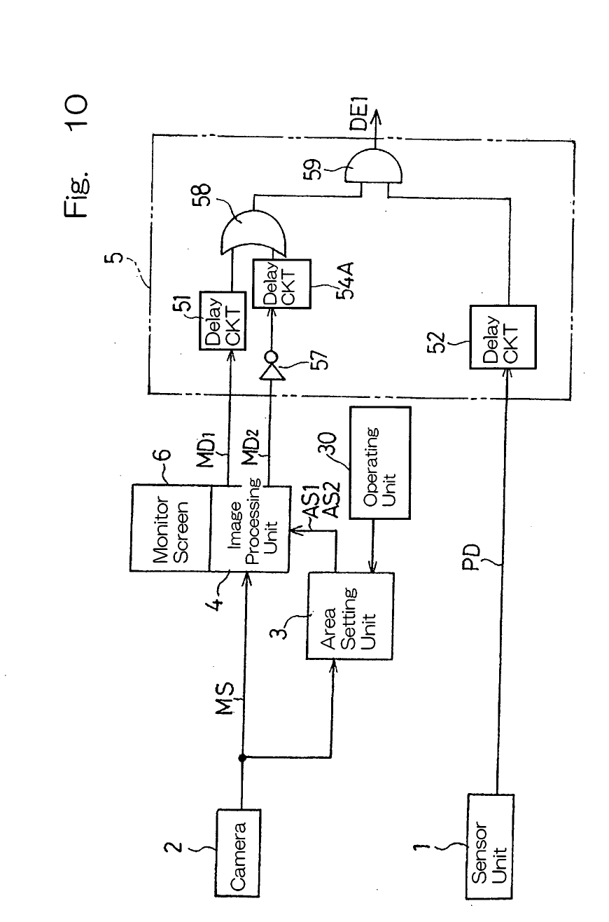

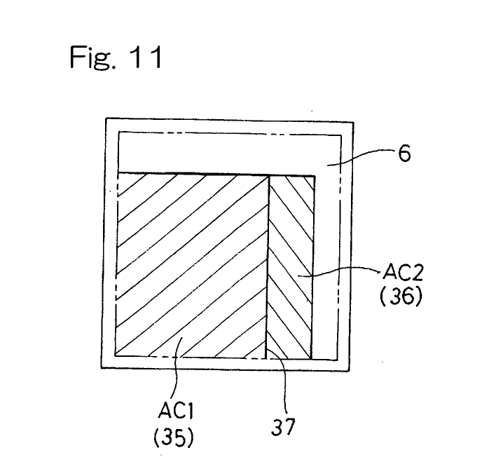

A sixth preferred embodiment of the present invention will now be described with particular reference to FIGS. 9 to 11. In this embodiment, as shown in FIG. 9, the field of view V2 of the camera 2 is chosen to be larger than the field of view V1 of the sensor unit 1. Within the field of view V2 of the camera 2, a fence 37 is set up to separate the premises 35 and an outside land 36 from each other, which outside land may be, for example, a road. In such case, although the field of view V1 of the sensor unit 1 extends to the outside land 36, arrangement is made so that even though the sensor unit 1 detects an object moving in the outside land 36, no object detection signal can be outputted (alarmed) since the outside land 36 is where vehicles and people both having no intention to enter the premises 35 move. On the other hand, since the premises 35 is within a short distance from the sensor unit 1, the reliability of detection of the intruding object with the sensor unit 1 is high and, therefore, the erroneous warning will not take place so often even though the object detection signal is outputted only based on the detection by the sensor unit 1. In view of this, through the area setting unit 3 shown in FIG. 10, the monitor screen 6 is so set as to display the premises 35 as a first specific area AC1 and the outside land 36 as a second specific area AC2, with the fence 37 taken as a boarder, as shown in FIG. 11.

As shown in FIG. 10, with the sensor-camera ganged intrusion detecting apparatus according to the sixth embodiment, when the video signal MS from the camera unit 2 watching the first and second specific areas AC1 and AC2 changes, the first and second detection signals MD1 and MD2 can be outputted from the image processing unit 4 to the detection signal generating unit 5. The detection signal generating unit 5 in the sixth embodiment includes a NOT circuit 57 for logically negating the second detection signal MD2, a first delay circuit 51 for delaying the first detection signal MD1, a second delay circuit 52 for delaying the detection signal PD from the sensor unit 1, a third delay circuit 54A for delaying a signal outputted from the NOT circuit 57, an OR circuit 58 to which respective output signals from the first and third delay circuits 51 and 54A are inputted, and an AND circuit 59 to which an output signal from the OR circuit 58 and an output signal from the second delay circuit 52 are supplied. With this circuit arrangement, when the detection signal generating unit 5 receives both of the detection signal PD from the sensor unit 1 and the detection signal MD1 from the image processing unit 4 in association with the first specific area AC1, or when it receives the detection signal PD from the sensor unit 1, but does not receive the detection signal MD2 from the image processing unit 4 in association with the second specific area AC2, the detection signal generating unit 5 generates the object detection signal DE1.

According to the sixth embodiment described above, when the detection signal MD2 associated with the second specific area AC2 of the outer land 36 is not outputted from the image processing unit 4 while the detection signal PD is outputted from the sensor unit 1, that is, when the camera 2 is not detecting an automotive vehicle and/or people in the outer land 36, the NOT circuit 57 outputs a high level signal to the OR circuit 58 which then outputs a high level signal to the AND circuit 59. The AND circuit 59 consequently outputs (alarms) the object detection signal DE1. In this condition, it is determined that the sensor unit 1 has detected the intruding object Q within the first specific area AC1 within the premises 35. Conversely, when the detection signal MD2 is outputted while the detection signal PD is outputted from the sensor unit 1, the NOT circuit 57 outputs a low level signal and, accordingly, the object detection signal DE1 is not outputted from the AND circuit 59. Accordingly, when the automotive vehicle and/or people having no intention to enter the premises 36 moves within the outer land 36 and the camera 2 detects such vehicle and/or people, no alarm is issued even though the sensor unit 1 outputs the detection signal PD indicative of such vehicle and/or people moving in the outer land 36.

On the other hand, when the camera 2 detects the intruding object Q within the first specific area AC1 of the premises 35 and the detection signal MD1 is subsequently outputted from the image processing unit 4 while the detection signal PD is outputted from the sensor unit 1, the OR circuit 58 outputs a high level signal and, therefore, the object detection signal DE1 is outputted (alarmed) from the AND circuit 59. Accordingly, if the intruding object Q is present within the first specific area AC1 of the premises 35 even when the automotive vehicle and/or people within the second specific area AC2 of the outer land 36 is detected by the camera 2 with the output signal from the NOT circuit 57 consequently rendered to be in a low level state, both of the sensor unit 1 and the camera 2 detects the presence of the intruding object Q within the first specific area AC1 and, therefore, the object detection signal DE1 can be outputted. The stable sensor-camera ganged intrusion detecting apparatus capable of assuredly detecting the presence of the intruding object Q within the first specific area AC1 can thus be obtained.

Although in the foregoing embodiments the passive infrared detector 11 of the PIR system has been shown and described as employed for the sensor unit 1, the AIR system may be employed, in which while near infrared rays are projected as detection rays, the near infrared rays reflected from an object are detected. Also, an active sensor of a radio wave system or of an ultrasonic system including transmitting and receiving elements for transmitting and receiving radio waves or ultrasonic waves as the detection rays may also be employed for the sensor unit 1.

What is claimed is:

1. A sensor-camera ganged intrusion detecting apparatus comprising:
a sensor unit for detecting an object in terms of a change in amount of reception of detection rays from a detection area;
an image processing unit for detecting the object in terms of a change of a video signal from a specific area in an area shot by a camera, the specific area having a portion overlapped with the detection area;
an area setting unit for setting the specific area on a monitor screen coupled with the camera; and
a detection signal generating unit for generating an object detection signal based on a detection signal from the sensor unit and a detection signal from/the image processing unit.

2. The sensor-camera ganged intrusion detecting apparatus as claimed in claim 1:
wherein the specific area includes first and second specific areas; and
wherein the detection signal generating unit generates the object detection signal in response to both of the detection signal from the sensor unit and the detection signal from the image processing unit in association with the first specific area or in response to the detection signal from the image processing unit in association with the second specific area.

3. The sensor-camera ganged intrusion detecting apparatus as claimed in claim 1:
wherein the specific area includes first and second specific areas; and
wherein the detection signal generating unit generates a first object detection signal in response to receipt of both of the detection signal from the sensor unit and the detection signal from the image processing unit in association with the first specific area and also generates a second object detection signal in response to receipt of the detection signal from the image processing unit in association with the second specific area.

4. The sensor-camera ganged intrusion detecting apparatus as claimed in claim 1, further comprising a nighttime adjusting device that is operable, when the brightness of an area shot by the camera becomes a value equal to or lower than a predetermined brightness, to disable the image processing unit and to allow the detection signal generating unit to generate a first object detection signal in response to only the detection signal from the sensor unit.

5. The sensor-camera ganged intrusion detecting apparatus as claimed in claim 1, wherein the detection rays are infrared rays; and
wherein the sensor-camera ganged intrusion detecting apparatus further comprises a temperature adjusting device that is operable, when the temperature of the detection area becomes a value equal to or higher than a predetermined temperature, to disable the sensor unit and to allow the detection signal generating unit to generate a first object detecting signal in response to only the detection signal from the image processing unit.

6. The sensor-camera ganged intrusion detecting apparatus as claimed in claim 1:
wherein the specific area includes first and second specific areas; and
wherein the detection signal generating unit generates the object detection signal when it receives both of the detection signal from the sensor unit and the detection signal from the image processing unit in association with the first specific area, or when it receives the detection signal from the sensor unit, but does not receive the detection signal from the image processing unit in association with the second specific area.

7. The sensor-camera ganged intrusion detecting apparatus as claimed in claim 1, wherein the sensor unit includes a passive infrared detector for detecting far infrared rays from the detection area.
